(19) United States
(12) Patent Application Publication
(10) Pub. No.: US 2026/0110062 A1
(43) Pub. Date: Apr. 23, 2026

(54) CEMENTED CARBIDE AND CUTTING TOOL

(71) Applicant: Sumitomo Electric Industries, Ltd., Osaka-shi, Osaka (JP)

(72) Inventors: Yoshihiro KIMURA, Osaka-shi, Osaka (JP); Yasuki KIDO, Osaka-shi, Osaka (JP); Anongsack PASEUTH, Osaka-shi, Osaka (JP)

(73) Assignee: Sumitomo Electric Industries, Ltd., Osaka-shi, Osaka (JP)

(21) Appl. No.: 19/134,762

(22) PCT Filed: Oct. 22, 2024
(86) PCT No.: PCT/JP2024/037558

§ 371 Date: Jun. 2, 2025

(51) Int. Cl. C22C 29/08; B22F 3/15; B22F 3/16; B23C 5/10; C22C 1/051; C22C 29/00; C22C 29/02; C22C 29/06

(52) U.S. Cl. CPC C22C 29/08; B22F 3/15; B22F 3/16; B23C 5/109; C22C 1/051; C22C 29/005; C22C 29/02; C22C 29/067; B22F 2201/02; B22F 2201/11; B22F 2301/15; B22F 2302/10; B22F 2302/25; B22F 2998/10; B22F 2999/00

(57) ABSTRACT

A cemented carbide including: a first hard phase composed of a plurality of tungsten carbide particles; a second hard phase composed of at least one first compound selected from the group consisting of TiNbC, TiNbN, TiNbCN, TiTaC, TiTaN, TiTaCN, TiTaNbC, TiTaNbN, and TiTaNbCN; and a binder phase, wherein a standard deviation sd of Heywood diameters of the tungsten carbide particles in the particle size distribution on a volume basis is 0.10 μm or more and 0.25 μm or less, a percentage of the number of the second hard phases having a diameter of 0.2 μm or less is 10% or more and 30% or less, and a percentage of the number of the second hard phases having a diameter of 0.6 μm or more is 10% or more and 30% or less.

### TECHNICAL FIELD

The present disclosure relates to a cemented carbide and a cutting tool.

### BACKGROUND ART

A cemented carbide that has a phase mainly composed of tungsten carbide (WC), a phase composed of a carbide containing a metal element other than tungsten, a nitride, a carbonitride, and the like, and a binder phase mainly composed of an iron-group element has been conventionally used for a material of a cutting tool (PTL 1).

### CITATION LIST

### Patent Literature

PTL 1: WO 2024/105882

### SUMMARY OF INVENTION

A cemented carbide of the present disclosure is a cemented carbide comprising a first hard phase, a second hard phase, and a binder phase, wherein the first hard phase is composed of a plurality of tungsten carbide particles, the second hard phase is composed of at least one first compound selected from the group consisting of TiNbC, TiNbN, TiNbCN, TiTaC, TiTaN, TiTaCN, TiTaNbC, TiTaNbN, and TiTaNbCN, the binder phase contains cobalt at 50 mass % or more, a total content of the first hard phase, the second hard phase, and the binder phase in the cemented carbide is 94 vol % or more, a content of the first hard phase in the cemented carbide is 65.0 vol % or more and 95.0 vol % or less, a content of the second hard phase in the cemented carbide is 0.1 vol % or more and 5.0 vol % or less, a content of the binder phase in the cemented carbide is 4.0 vol % or more and 25.0 vol % or less, a standard deviation sd of Heywood diameters of the tungsten carbide particles in the particle size distribution on a volume basis is 0.10 μm or more and 0.25 μm or less, a percentage of the number of the second hard phases having a diameter of 0.2 μm or less relative to the number of all of the second hard phases is 10% or more and 30% or less, and a percentage of the number of the second hard phases having a diameter of 0.6 μm or more relative to the number of all of the second hard phases is 10% or more and 30% or less.

### BRIEF DESCRIPTION OF DRAWINGS

FIG. 1 is a schematic diagram of a cutting tool (endmill) according to Embodiment 2.

FIG. 2 is a schematic diagram of a cutting tool (indexable cutting insert) according to Embodiment 2.

### DETAILED DESCRIPTION

### Problem to be Solved by the Present Disclosure

From the viewpoint of cost reduction, a cemented carbide that can lengthen the lifetime of a tool even when used as a material of a cutting tool for high-speed processing of titanium alloy and stainless steel, and a cutting tool comprising the same have been required.

### Advantageous Effect of the Present Disclosure

According to the present disclosure, a cemented carbide that can lengthen the lifetime of a tool even when used as a material of a cutting tool for high-speed processing of titanium alloy and stainless steel, and a cutting tool comprising the same can be provided.

### Description of Embodiments

First, aspects of the present disclosure will be listed and described.
(1) A cemented carbide of the present disclosure is a cemented carbide comprising a first hard phase, a second hard phase, and a binder phase, wherein the first hard phase is composed of a plurality of tungsten carbide particles, the second hard phase is composed of at least one first compound selected from the group consisting of TiNbC, TiNbN, TiNbCN, TiTaC, TiTaN, TiTaCN, TiTaNbC, TiTaNbN, and TiTaNbCN, the binder phase contains cobalt at 50 mass % or more, a total content of the first hard phase, the second hard phase, and the binder phase in the cemented carbide is 94 vol % or more, a content of the first hard phase in the cemented carbide is 65.0 vol % or more and 95.0 vol % or less, a content of the second hard phase in the cemented carbide is 0.1 vol % or more and 5.0 vol % or less, a content of the binder phase in the cemented carbide is 4.0 vol % or more and 25.0 vol % or less, a standard deviation sd of Heywood diameters of the tungsten carbide particles in the particle size distribution on a volume basis is 0.10 μm or more and 0.25 μm or less, a percentage of the number of the second hard phases having a diameter of 0.2 μm or less relative to the number of all of the second hard phases is 10% or more and 30% or less, and a percentage of the number of the second hard phases having a diameter of 0.6 μm or more relative to the number of all of the second hard phases is 10% or more and 30% or less.

According to the present disclosure, a cemented carbide that can lengthen the lifetime of a tool even when used as a material of a cutting tool for high-speed processing of titanium alloy and stainless steel, and a cutting tool comprising the same can be provided. The reason is presumed as follows.

The cemented carbide of the present disclosure contains the first hard phase composed of a plurality of tungsten carbide particles (also referred to as “WC particles”), the second hard phase composed of TiNbC and the like, and a binder phase in a total amount of 94 vol % or more, and a content of the first hard phase is 65.0 vol % or more and 95.0 vol % or less, a content of the second hard phase is 0.1 vol % or more and 5.0 vol % or less, and a content of the binder phase is 4.0 vol % or more and 25.0 vol % or less. According to this, the cemented carbide can have hardness and toughness suitable for a cutting tool.

In the cemented carbide of the present disclosure, a standard deviation sd of Heywood diameters of the tungsten carbide particles in the particle size distribution on a volume basis is 0.10 μm or more and 0.25 μm or less, and the width of the particle size distribution of the tungsten carbide particles is narrow and sharp. According to this, the cemented carbide can be decreased in defects by forming a homogeneous microstructure, and can have excellent fracture toughness.

In the cemented carbide of the present disclosure, a percentage of the number of the second hard phases having a diameter of 0.2 μm or less relative to the number of all of the second hard phases is 10% or more and 30% or less, a percentage of the number of the second hard phases having a diameter of 0.6 μm or more relative to the number of all of the second hard phases is 10% or more and 30% or less, and the width of the particle size distribution of the second hard phase is wide and broad. According to this, the cemented carbide contains large second hard phases having a diameter of 0.6 μm or more, and therefore, it can have excellent welding resistance and oxidation resistance. Moreover, the cemented carbide contains high-hardness and fine second hard phases having a diameter of 0.2 μm or less, and therefore, it can have excellent wearing resistance. In the present disclosure, the diameters of the second hard phases mean Heywood diameters of a plurality of crystal grains that constitute the second hard phases in the cross section of the cemented carbide.
(2) According to the above (1), a volume mean diameter mv of the tungsten carbide particles may be 0.2 μm or more and 0.65 μm or less. According to this, fracture toughness of the cemented carbide is further improved. When the volume mean diameter mv of the tungsten carbide particles is 0.2 μm or more, toughness of the cemented carbide is improved. When the volume mean diameter mv of the tungsten carbide particles is 0.65 μm or less, hardness of the cemented carbide is improved.
(3) According to the above (1) or (2), the cemented carbide further comprises a third hard phase, the third hard phase is composed of at least one second compound selected from the group consisting of TiWNbC, TiWNbN, TiWNbCN, TiWTaC, TiWTaN, TiWTaCN, TiTaWNbC, TiTaWNbN, and TiTaWNbCN, and a content of the third hard phase in the cemented carbide may be 0.1 vol % or more and 5 vol % or less. When the content of the third hard phase in the cemented carbide is 0.1 vol % or more, fracture toughness is improved. When the content of the third hard phase in the cemented carbide is 5 vol % or less, strength is improved.
(4) According to the above (3), a cumulative 50% particle diameter D50 of the third hard phase on an area basis (also referred to as “D50 of the third hard phase” hereinafter) may be 0.1 μm or more and 3.0 μm or less. When D50 of the third hard phase is 0.1 μm or more, fracture toughness is improved. When D50 of the third hard phase is 3.0 μm or less, strength is improved.
(5) A cutting tool of the present disclosure comprises a cutting edge composed of the cemented carbide according to any of the above (1) to (4). The cutting tool of the present disclosure can have a long lifetime even when used for high-speed processing of titanium alloy and stainless steel.

### Detailed Description of Embodiments

With reference to the drawings, specific examples of the cemented carbide and the cutting tool of the present disclosure will be described hereinafter. In the drawings of the present disclosure, a same reference sign represents same parts or corresponding parts. Dimensions such as length, width, thickness, and depth are appropriately modified to clarify and simplify the drawings, and do not always represent actual dimensions.

A description of a form “A to B” herein means A or more and B or less, and when A has no description of a unit and only B has a description of a unit, the unit of A and the unit of B are same.

When a compound and the like are represented by a chemical formula herein, any conventionally known atomic ratios are included unless the atomic ratio is particularly limited, and should not be necessarily limited to only an atomic ratio within a stoichiometric range.

When one or more numerical values are described herein as the lower limit and the upper limit of the numerical value range, a combination of any one numerical value described as the lower limit and any one numerical value described as the upper limit is also disclosed.

In the present disclosure, “comprise”, “contain”, “have”, and modifications of these are open-end terms. The open-end terms may further contain, in addition to the essential elements, additional elements, or may not contain them. A description “consisting of” is a closed term. However, even if the constitution is expressed by a closed term, it can include an additional element that is an impurity usually associated or that is independent of the objective art.

### Embodiment 1: Cemented Carbide

A cemented carbide of an embodiment of the present disclosure (hereinafter, also referred to as “Embodiment 1”) is a cemented carbide comprising a first hard phase, a second hard phase, and a binder phase, wherein the first hard phase is composed of a plurality of tungsten carbide particles, the second hard phase is composed of at least one first compound selected from the group consisting of TiNbC, TiNbN, TiNbCN, TiTaC, TiTaN, TiTaCN, TiTaNbC, TiTaNbN, and TiTaNbCN, the binder phase contains cobalt at 50 mass % or more, a total content of the first hard phase, the second hard phase, and the binder phase in the cemented carbide is 94 vol % or more, a content of the first hard phase in the cemented carbide is 65.0 vol % or more and 95.0 vol % or less, a content of the second hard phase in the cemented carbide is 0.1 vol % or more and 5.0 vol % or less, a content of the binder phase in the cemented carbide is 4.0 vol % or more and 25.0 vol % or less, a standard deviation sd of Heywood diameters of the tungsten carbide particles in the particle size distribution on a volume basis is 0.10 μm or more and 0.25 μm or less, a percentage of the number of the second hard phases having a diameter of 0.2 μm or less relative to the number of all of the second hard phases is 10% or more and 30% or less, and a percentage of the number of the second hard phases having a diameter of 0.6 μm or more relative to the number of all of the second hard phases is 10% or more and 30% or less.

### <Composition of Cemented Carbide>

The cemented carbide of Embodiment 1 comprises the first hard phase, the second hard phase, and the binder phase. A total content of the first hard phase, the second hard phase, and the binder phase in the cemented carbide is 94 vol % or more, may be 94 vol % or more and 100 vol % or less, may be 95.0 vol % or more and 99.9 vol % or less, may be 96.0 vol % or more and 99.3 vol % or less, or may be 98.0 vol % or more and 99.2 vol % or less.

A content of the first hard phase in the cemented carbide of Embodiment 1 is 65.0 vol % or more and 95.0 vol % or less, may be 68.0 vol % or more and 94.0 vol % or less, may be 70.0 vol % or more and 92.0 vol % or less, or may be 80.0 vol % or more and 90.0 vol % or less.

A content of the second hard phase in the cemented carbide of Embodiment 1 is 0.1 vol % or more and 5.0 vol % or less, may be 0.2 vol % or more and 4.9 vol % or less, may be 0.5 vol % or more and 4.0 vol % or less, or may be 0.7 vol % or more and 3.0 vol % or less.

A content of the binder phase in the cemented carbide of Embodiment 1 is 4.0 vol % or more and 25.0 vol % or less, may be 7.0 vol % or more and 20.0 vol % or less, or may be 10.0 vol % or more and 18.0 vol % or less.

The cemented carbide of Embodiment 1 may further comprise a third hard phase in addition to the first hard phase, the second hard phase, and the binder phase. The third hard phase is composed of at least one second compound selected from the group consisting of TiWNbC, TiWNbN, TiWNbCN, TiWTaC, TiWTaN, TiWTaCN, TiTaWNbC, TiTaWNbN, and TiTaWNbCN.

A content of the third hard phase in the cemented carbide of Embodiment 1 may be 0.1 vol % or more and 5 vol % or less, may be 0.2 vol % or more and 4.7 vol % or less, may be 0.5 vol % or more and 4.0 vol % or less, or may be 0.7 vol % or more and 3.5 vol % or less.

The cemented carbide of Embodiment 1 may be composed of the first hard phase, the second hard phase, and the binder phase. The cemented carbide of Embodiment 1 may be composed of the first hard phase, the second hard phase, the binder phase, and an impurity as long as the effect of the present disclosure is not impaired. The cemented carbide of Embodiment 1 may be composed of the first hard phase, the second hard phase, the binder phase, and the third hard phase. The cemented carbide of Embodiment 1 may be composed of the first hard phase, the second hard phase, the binder phase, the third hard phase, and an impurity as long as the effect of the present disclosure is not impaired.

Examples of the impurity include iron (Fe), calcium (Ca), silicon (Si), and sulfur(S). A content of the impurity in the cemented carbide is acceptable within the limits of not impairing the effect of the present disclosure. For example, a content of the impurity in the cemented carbide may be 0 mass % or more and less than 0.1 mass %. The content of the impurity in the cemented carbide is measured by Inductively Coupled Plasma (ICP) Emission Spectroscopy. As the measurement apparatus, “ICPS-8100”™ manufactured by SHIMADZU CORPORATION can be used.

Methods for measuring the content of the first hard phase, content of the second hard phase, content of the binder phase, and content of the third hard phase in the cemented carbide are as follows.
(A1) A given position of the cemented carbide is cut to expose a cross section. The cross section is subjected to mirror-surface processing using a cross-section polisher (manufactured by JEOL Ltd.).
(B1) The mirror-surface processed surface of the cemented carbide is micrographed with a scanning electron microscope (SEM) to obtain a backscattered electron image. The micrographed regions are set to central portions of the cross section of the cemented carbide (where the micrographed regions are all the bulk portions of the cemented carbide), namely positions that do not include a portion where properties obviously differ from those of the bulk portion, such as a proximity of the surface of the cemented carbide. An observation magnification is 5000. The measurement conditions are an acceleration voltage of 3 kV, a current value of 2 nA, and a working distance (WD) of 5 mm.
(C1) The backscattered electron image obtained in the above (B1) is input into a computer to perform a binarization process using an image analysis software (ImageJ ver. 1.51J8). In an image after the binarization process, the first region composed of the first hard phase and the second region composed of the binder phase, the second hard phase, and the third hard phase can be identified by the shade of color. For example, in an image after the binarization process, the first region (the first hard phase) is indicated in black, and the second region (the binder phase, the second hard phase, and the third hard phase) is indicated in white.
(D1) The micrographed regions of the above (B1) are subjected to analysis by using an energy dispersive X-ray analyzer (SEM-EDX) (apparatus: Gemini 450™ manufactured by Carl Zeiss AG) attached to the scanning electron microscope to obtain an elemental mapping image.
(E1) The image after the binarization process obtained in the above (C1) and the elemental mapping image obtained in the above (D1) are overlapped to specify existence regions of each of the first hard phase, the second hard phase, the binder phase, and the third hard phase on the image after the binarization process.

A region indicated in black in the image after the binarization process and in which tungsten (W) and carbon (C) are present in the elemental mapping image corresponds to the existence region of the first hard phase.

A region indicated in white in the image after the binarization process and in which cobalt (Co) is present in the elemental mapping image corresponds to the existence region of the binder phase.

A region indicated in white in the image after the binarization process and in which at least one first compound selected from the group consisting of TiNbC, TiNbN, TiNbCN, TiTaC, TiTaN, TiTaCN, TiTaNbC, TiTaNbN, and TiTaNbCN is present in the elemental mapping image corresponds to the existence region of the second hard phase.

A region indicated in white in the image after the binarization process and in which at least one second compound selected from the group consisting of TiWNbC, TiWNbN, TiWNbCN, TiWTaC, TiWTaN, TiWTaCN, TiTaWNbC, TiTaWNbN, and TiTaWNbCN is present in the elemental mapping image corresponds to the existence region of the third hard phase.
(F1) A rectangular measurement field with 24.9 μm×18.8 μm is set in the image after the binarization process. Using the above image analysis software, an area percentage of each of the first hard phase, the binder phase, the second hard phase, and the third hard phase is measured based on an area of an entirety of the measurement field as a denominator.
(G1) The measurement of the above (F1) is performed in the five different measurement fields that are not overlapped with each other. In the present disclosure, an average of the area percentages of the first hard phase in the five measurement fields corresponds to the content (vol %) of the first hard phase in the cemented carbide. An average of the area percentages of the second hard phase in the five measurement fields corresponds to the content (vol %) of the second hard phase in the cemented carbide. An average of the area percentages of the binder phase in the five measurement fields corresponds to the content (vol %) of the binder phase in the cemented carbide. An average of the area percentages of the third hard phase in the five measurement fields corresponds to the content (vol %) of the third hard phase in the cemented carbide.

It has been confirmed that even when a plurality of measurements is performed by varying the selected portions of the measurement field, the measurement results have almost no variation as long as the identical sample is measured.

### <First Hard Phase>

### «Composition of First Hard Phase»

In the cemented carbide of Embodiment 1, the first hard phase is composed of a plurality of tungsten carbide particles. The tungsten carbide particles include not only “pure WC particles (containing WC that contains no impurity element at all, and WC in which the content of impurity elements is less than the detection limit)” but also “WC particles containing impurity inside as long as the effect of the present disclosure is not impaired”. Examples of the impurity include iron (Fe), molybdenum (Mo), and sulfur (S).

### «Standard Deviation sd of Heywood Diameters of Tungsten Carbide Particles in Particle Size Distribution on Volume Basis»

In the cemented carbide of Embodiment 1, a standard deviation sd of Heywood diameters of the tungsten carbide particles in the particle size distribution on a volume basis is 0.10 μm or more and 0.25 μm or less, may be 0.13 μm or more and 0.23 μm or less, may be 0.16 μm or more and 0.23 μm or less, or may be 0.17 μm or more and 0.20 μm or less.

### «Volume Mean Diameter mv of Tungsten Carbide Particles»

In the cemented carbide of Embodiment 1, a volume mean diameter mv of the tungsten carbide particles may be 0.2 μm or more and 0.65 μm or less, may be 0.20 μm or more and 0.60 μm or less, may be 0.30 μm or more and 0.50 μm or less, or may be 0.30 μm or more and 0.40 μm or less.

In the present disclosure, the methods for measuring the standard deviation sd of Heywood diameters of the tungsten carbide particles in the particle size distribution on a volume basis in the cemented carbide, and the volume mean diameter mv of the tungsten carbide particles are as follows.
(A2) In an image after the binarization process, an existence region of the first hard phase is specified in the same manner as in (A1) to (E1) of the above method for measuring the content of the first hard phase or the like in the cemented carbide.
(B2) Five images after the binarization process in which an existence region of the first hard phase has been specified are prepared, and in each image, a rectangular measurement field with 40.3 μm in length×30.2 μm in width is set. Using an image analysis software (“Mac-View Version 5”™ manufactured by Mountech Co., Ltd.), Heywood diameters (projected area equivalent circle diameters) of the tungsten carbide particles in the measurement field are measured, and based on these, a standard deviation sd of Heywood diameters of the tungsten carbide particles in the particle size distribution on a volume basis, and a volume mean diameter mv of the tungsten carbide particles in the measurement field are calculated. The Mac-View setting conditions are non-spherical, a detection sensitivity of 20, and a detection accuracy of 0.7.
(C2) An average of the standard deviations sd of Heywood diameters of the tungsten carbide particles in the particle size distributions on a volume basis in the five measurement fields is calculated. In the present disclosure, the average corresponds to the standard deviation sd of Heywood diameters of the tungsten carbide particles in the particle size distribution on a volume basis.

An average of volume mean diameters mv of the tungsten carbide particles in the five measurement fields is calculated. In the present disclosure, the average corresponds to the volume mean diameter mv of the tungsten carbide particles.

It has been confirmed that even when a plurality of measurements is performed by varying the selected portions of the measurement field, the measurement results have almost no variation as long as the identical sample is measured.

### <Second Hard Phase>

### «Composition»

In Embodiment 1, the second hard phase is composed of at least one first compound selected from the group consisting of TiNbC, TiNbN, TiNbCN, TiTaC, TiTaN, TiTaCN, TiTaNbC, TiTaNbN, and TiTaNbCN. In the first compound, the ratio between the total of the numbers of atoms of Ti, Nb, and Ta and the total of the numbers of atoms of C and N is not limited to 1:1, and any conventionally known ratios are included as long as the effect of the present disclosure is not impaired.

The second hard phase may contain metal elements, such as chromium (Cr), vanadium (V), and cobalt (Co), as long as the effect of the present disclosure is not impaired. A total content of Cr and Co in the second hard phase may be 0 mass % or more and less than 0.1 mass %. The contents of Cr and Co in the second hard phase are measured by STEM-EDX.

### «Particle Size Distribution of Second Hard Phase>

In the cemented carbide of Embodiment 1, a percentage of the number of the second hard phases having a diameter of 0.2 μm or less relative to the number of all of the second hard phases is 10% or more and 30% or less, and a percentage of the number of the second hard phases having a diameter of 0.6 μm or more relative to the number of all of the second hard phases is 10% or more and 30% or less.

In the cemented carbide of Embodiment 1, a percentage of the number of the second hard phases having a diameter of 0.2 μm or less relative to the number of all of the second hard phases may be 12% or more and 28% or less, or may be 15% or more and 25% or less. In the cemented carbide of Embodiment 1, a percentage of the number of the second hard phases having a diameter of 0.6 μm or more relative to the number of all of the second hard phases may be 12% or more and 27% or less, or may be 14% or more and 26% or less. The percentage of the number of the second hard phases having a diameter of 0.2 μm or less and the percentage of the number of the second hard phases having a diameter of 0.6 μm or more can be appropriately combined.

In the present disclosure, the method for measuring the particle size distribution of the second hard phases in the cemented carbide is as follows.
(A3) A given position of the cemented carbide is cut to expose a cross section. The cross section is subjected to mirror-surface processing using a cross-section polisher (manufactured by JEOL Ltd.).
(B3) The mirror-surface processed surface of the cemented carbide is subjected to analysis by using SEM-EDX (apparatus: Gemini 450™ manufactured by Carl Zeiss AG) to obtain an elemental mapping image. In the elemental mapping image, the second hard phase composed of at least one first compound selected from the group consisting of TiNbC, TiNbN, TiNbCN, TiTaC, TiTaN, TiTaCN, TiTaNbC, TiTaNbN, and TiTaNbCN is specified.
(C3) In the elemental mapping image, a measurement field having an area of 20000 μm² or more and having the number of the second hard phases of 500 or more is set.
(D3) The elemental mapping image is input into a computer, and the measurement field is analyzed by using a microscope imaging software (“LAS X2D Analysis”™ manufactured by Leica Microsystems GmbH) to measure a particle size distribution of Heywood diameters of the second hard phases on a basis of the number of particles. In the analysis, threshold adjustment is performed by filter processing that is pre-installed in the microscope imaging software. The filter processing conditions may be, for example, color regions of H0-357, S90-255, and I0-110.

Based on the resulting particle size distribution of the second hard phases, a percentage of the number of the second hard phases having a diameter of 0.2 μm or less relative to the number of all of the second hard phases, and a percentage of the number of the second hard phases having a diameter of 0.6 μm or more relative to the number of all of the second hard phases are calculated.

It has been confirmed that even when a plurality of measurements is performed by varying the selected portions of the measurement field, the measurement results have almost no variation as long as the identical sample is measured.

In the cemented carbide of Embodiment 1, the second hard phase is composed of a plurality of crystal grains. Examples of the crystal grains include a first compound particle composed of one first compound selected from the group consisting of TiNbC, TiNbN, TiNbCN, TiTaC, TiTaN, TiTaCN, TiTaNbC, TiTaNbN, and TiTaNbCN, and a first compound particle composed of two or more first compounds.

The second hard phase can also be expressed as being composed of a plurality of first compound particles. In the present disclosure, the particle size distribution of the second hard phase has the same meaning as the grain size distribution of a plurality of crystal grains that constitute the second hard phase, and the particle size distribution of the first compound particles.

### <Binder Phase>

### «Composition of Binder Phase»

In the cemented carbide of Embodiment 1, a cobalt content in the binder phase is 50 mass % or more. According to this, the cemented carbide can have excellent toughness. The cobalt content in the binder phase may be 80 mass % or more and 100 mass % or less, or may be 90 mass % or more and 100 mass % or less.

A method for measuring the content of cobalt in the binder phase is as follows. An elemental mapping image and an image after the binarization process are obtained in the same manner as in (A1) to (E1) of the above method for measuring the content of the first hard phase or the like in the cemented carbide. By overlapping the elemental mapping image with the image after the binarization process, an existence region of the binder phase is specified in the elemental mapping image. A rectangular measurement field with 24.9 μm×18.8 μm is set in the image of the elemental mapping image. In the existence region of the binder phase in the measurement field, a cobalt content is measured. The above measurement is performed in five different measurement fields that do not overlap with each other. In the present disclosure, an average of the cobalt contents in the existence regions of the binder phases in the five measurement fields corresponds to the cobalt content in the binder phase.

It has been confirmed that even when a plurality of measurements is performed by varying the selected portions of the measurement field, the measurement results have almost no variation as long as the identical sample is measured.

In the cemented carbide of Embodiment 1, the binder phase can further contain a first element selected from the group consisting of iron (Fe), nickel (Ni), chromium (Cr), vanadium (V), titanium (Ti), niobium (Nb), and tantalum (Ta) as long as the effect of the present disclosure is not impaired. The binder phase can be composed of cobalt and the first element.

### <Third Hard Phase>

### «Composition»

In Embodiment 1, the third hard phase is composed of at least one second compound selected from the group consisting of TiWNbC, TiWNbN, TiWNbCN, TiWTaC, TiWTaN, TiWTaCN, TiTaWNbC, TiTaWNbN, and TiTaWNbCN. In the second compound, the ratio between the total of the numbers of atoms of Ti, W, Nb, and Ta and the total of the numbers of atoms of C and N is not limited to 1:1, and any conventionally known ratios are included as long as the effect of the present disclosure is not impaired.

The third hard phase may contain metal elements, such as chromium (Cr), vanadium (V), and cobalt (Co), as long as the effect of the present disclosure is not impaired. A total content of Cr and Co in the third hard phase may be 0 mass % or more and less than 0.1 mass %. The contents of Cr and Co in the third hard phase are measured by STEM-EDX.

«Cumulative 50% Particle Diameter D50 of Third Hard Phase on Area Basis»

In the cemented carbide of Embodiment 1, a cumulative 50% particle diameter D50 of the third hard phase on an area basis is 0.1 μm or more and 3.0 μm or less, may be 0.2 μm or more and 2.9 μm or less, may be 0.4 μm or more and 2.2 μm or less, or may be 0.5 μm or more and 2.0 μm or less.

In the present disclosure, a method for measuring a cumulative 50% particle diameter D50 of the third hard phase on an area basis in the cemented carbide is as follows.
(A4) A given position of the cemented carbide is cut to expose a cross section. The cross section is subjected to mirror-surface processing using a cross-section polisher (manufactured by JEOL Ltd.).
(B4) The mirror-surface processed surface of the cemented carbide is subjected to analysis by using SEM-EDX (apparatus: Gemini 450™ manufactured by Carl Zeiss AG) to obtain an elemental mapping image. In the elemental mapping image, the third hard phase composed of at least one second compound selected from the group consisting of TiWNbC, TiWNbN, TiWNbCN, TiWTaC, TiWTaN, TiWTaCN, TiTaWNbC, TiTaWNbN, and TiTaWNbCN is specified.
(C4) 10 Elemental mapping images in which the third hard phase has been specified are prepared, and in each elemental mapping image, a rectangular measurement field with 4.0 μm in length×3.0 μm in width is set.
(D4) The elemental mapping image is input into a computer, and the measurement field is analyzed by using a microscope imaging software (“LAS X2D Analysis”™ manufactured by Leica Microsystems GmbH) to measure Heywood diameters (projected area equivalent circle diameters) of the third hard phases in the measurement field.
(E4) Based on all of the third hard phases in the 10 measurement fields, a cumulative 50% particle diameter D50 of the Heywood diameters of the third hard phases on an area basis is calculated.

It has been confirmed that even when a plurality of measurements is performed by varying the selected portions of the measurement field, the measurement results have almost no variation as long as the identical sample is measured.

In the cemented carbide of Embodiment 1, the third hard phase is composed of a plurality of crystal grains. Examples of the crystal grains include a second compound particle composed of one second compound selected from the group consisting of TiWNbC, TiWNbN, TiWNbCN, TiWTaC, TiWTaN, TiWTaCN, TiTaWNbC, TiTaWNbN, and TiTaWNbCN, and a second compound particle composed of two or more second compounds. The third hard phase can also be expressed as being composed of a plurality of second compound particles. In the present disclosure, the cumulative 50% particle diameter D50 of Heywood diameters of the third hard phase on an area basis has the same meaning as the cumulative 50% particle diameter D50 of Heywood diameters of a plurality of crystal grains that constitute the third hard phase on an area basis, and the cumulative 50% particle diameter D50 of Heywood diameters of the second compound particles on an area basis.

### <Method for Manufacturing Cemented Carbide>

The cemented carbide of Embodiment 1 can be manufactured by performing a preparation step of raw material powders, a mixing step, a shaping step, a sintering step, and a HIP step in the above order. Hereinafter, each step will be described.

### <Preparation Step>

The preparation step is a step of preparing raw materials of materials that constitute the cemented carbide. Examples of the raw materials include tungsten carbide (WC) powder (average particle diameter 0.45 μm to 0.49 μm), Co powder (average particle diameter 1 μm), TaC powder (average particle diameter 1 μm), TiO₂ powder (“TTO-V-3” manufactured by ISHIHARA SANGYO KAISHA, LTD.), and Nb(OH)₅ powder (“niobium hydroxide” manufactured by MITSUI MINING & SMELTING CO., LTD.).

When both of the TiO₂ powder and the Nb(OH)₅ powder are used, these are introduced into water and strongly stirred with an attritor to prepare a TiO₂—Nb₂O₅ precursor solution.

As the raw material powders, Ni powder, VC powder, Cr₃C₂ powder, and the like can be further prepared. As these raw material powders, commercially available ones can be used. The average particle diameters of these raw material powers cannot be particularly restricted, and can be, for example, 0.5 μm to 2 μm.

The average particle diameter of the raw material powder means an average particle diameter measured by FSSS (Fisher Sub-Sieve Sizer) method. The average particle diameter is measured by using “Sub-Sieve Sizer Model 95”™ manufactured by Fisher Scientific International Inc.

### <Mixing Step>

The mixing step is a step of mixing the raw materials (containing the TiO₂—Nb₂O₅ precursor solution) prepared in the preparation step, at a predetermined ratio to obtain a mixture. The mixing ratio of the raw materials is appropriately adjusted according to the desired composition of the cemented carbide.

For mixing the raw materials, a ball mill is used. The mixing conditions are the number of revolutions of 66 rpm, a ball diameter φ of 6 mm, and a mixing time of 24 hours.

After the mixing step, the mixture may be granulated if needed. By granulating the mixture, a die or a mold is easily filled with the mixture during the shaping step described later. To the granulation, a conventionally known granulating method can be applied, and for example, a commercially available granulator such as a spray dryer can be used.

### <Shaping Step>

The shaping step is a step of shaping the mixture obtained in the mixing step, into a shape for a cutting tool to obtain a green body. As the shaping method and shaping conditions in the shaping step, common method and conditions may be adopted, and not particularly limited.

### <Sintering Step>

The sintering step is a step of sintering the green body obtained in the shaping step to obtain a cemented carbide intermediate body. The green body is placed into a furnace, and heated up to 1350° C. at a heating rate of 20° C./min in an Ar atmosphere and at a pressure of 6.7 kPa, or in an N₂ atmosphere and at a pressure of 30 kPa or 6.7 kPa, 1350° C., and held at 1350° C. for 2 hours. Subsequently, the green body is cooled down to 25° C. at a cooling rate of −50° C./min to obtain a cemented carbide intermediate body.

### <HIP Step>

In the HIP step, the cemented carbide intermediate body is subjected to HIP. As the HIP conditions, the cemented carbide intermediate body is held for 2 hours in an Ar atmosphere, at 200 MPa, and at 1100° C. Thereafter, the intermediate body is cooled to obtain a cemented carbide of Embodiment 1. As the cooling conditions, conventionally known conditions can be used.

### <Features of Method for Manufacturing Cemented Carbide of Embodiment 1>

In the method for manufacturing the cemented carbide of Embodiment 1, TiO₂ powder and Nb(OH)₅ powder are introduced into water when both of these are used, and these are strongly stirred with an attritor to prepare a TiO₂—Nb₂O₅ precursor solution. According to this, in the mixture, the particle size distribution of the second hard phase containing Ti and Nb tends to become broad. In a conventional common method for manufacturing cemented carbide, the TiO₂—Nb₂O₅ precursor solution is not used, and therefore, in the particle size distribution of the second hard phase containing Ti and Nb, the percentage of the number of the second hard phases having a diameter of 0.2 μm or less relative to the number of all of the second hard phases cannot be set to 10% or more and 30% or less, neither can be set the percentage of the number of the second hard phases having a diameter of 0.6 μm or more relative to the number of all of the second hard phases to 10% or more and 30% or less.

In the mixing step in the method for manufacturing the cemented carbide of Embodiment 1, the raw materials are mixed with a low-speed ball mill. According to this, the particle size distribution of WC particles easily becomes sharp. Conventional common mixing conditions are, for example, use of an attritor, the number of revolutions of 100 rpm, a ball diameter ø of 6 mm, and a mixing time of 6 hours. According to this, the standard deviation sd of Heywood diameters of the WC particles in the particle size distribution on a volume basis cannot be set to 0.10 μm or more and 0.25 μm or less.

In the sintering step in the method for manufacturing the cemented carbide of Embodiment 1, the green body is held at 1350° C. for 2 hours. This is low-temperature long-time sintering. According to this, grain growth of the WC particles is suppressed, and a sharp particle size distribution of the WC particles tends to be maintained. Moreover, grain growth of the second hard phase is also suppressed, and a broad particle size distribution of the second hard phase tends to be maintained. The conventional sintering condition is, for example, holding at 1400° C. for 1 hour. According to this, the WC particles and the second hard phase tend to undergo grain growth, a sharp particle size distribution of the WC particles is difficult to maintain, and a broad particle size distribution of the second hard phase is difficult to maintain.

In the HIP step in the method for manufacturing the cemented carbide of Embodiment 1, low-temperature HIP is performed. According to this, the cemented carbide structure is densified, and grain growth of WC is suppressed, so that a sharp particles size distribution of the WC particles tends to be maintained. In a conventional common method for manufacturing cemented carbide, HIP is not performed often from the viewpoint of cost reduction, or even when HIP is performed, densification of the cemented carbide and suppression of grain growth of WC are insufficient because of a high temperature (for example 1300° C.).

As a result of intensive studies, the present inventors have found that the cemented carbide of the present disclosure can be realized by adopting the above manufacturing step.

### Embodiment 2: Cutting Tool

The cutting tool of an embodiment of the present disclosure (also referred to as “Embodiment 2” hereinafter) comprises a cutting edge composed of the cemented carbide of Embodiment 1. In the present disclosure, the cutting edge means a part involved with cutting. More specifically, the cutting edge means a region enclosed with a cutting edge ridgeline and an imaginary plane in which a distance from the cutting edge ridgeline to the cemented carbide side is 0.5 mm or 2 mm.

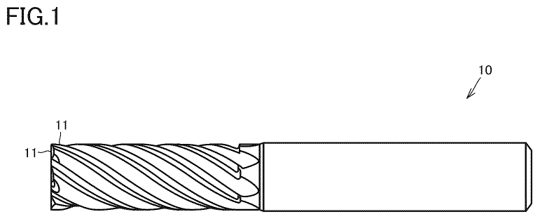

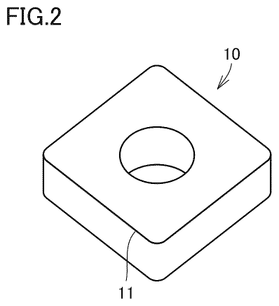

Examples of the cutting tool include a cutting bite, a drill, an endmill, an indexable cutting insert for milling, an indexable cutting insert for turning, a metal saw, a gear-cutting tool, a reamer, and a tap. The cutting tool 10 of Embodiment 2 exhibits an excellent effect particularly when it is such an endmill as shown in FIG. 1 and it is such an indexable cutting insert as shown in FIG. 2. A cutting edge 11 of the cutting tool 10 shown in each of FIG. 1 and FIG. 2 is composed of the cemented carbide of Embodiment 1.

In the cutting tool of Embodiment 2, the cemented carbide of Embodiment 1 may constitute the whole of each of these tools, or may constitute part thereof. In this regard, “constitute part” indicates an aspect wherein the cemented carbide of Embodiment 1 is brazed to a predetermined position of a given base material to form a cutting edge portion.

The cutting tool of Embodiment 2 may further comprise a hard film that covers at least part of a surface of a base material composed of the cemented carbide. As the hard film, for example, diamond-like carbon or diamond can be used.

The cutting tool of Embodiment 2 can be obtained by shaping the cemented carbide of Embodiment 1 into a desired shape.

### Examples

The present embodiments will be more specifically described with Examples. However, the present embodiments are not limited by these Examples.

### <Preparation Step>

As raw materials, tungsten carbide (WC) powder (“WC04NRP” manufactured by A.L.M.T. Corp., average particle diameter 0.45 μm to 0.49 μm), Co powder (manufactured by Kojundo Chemical Laboratory Co., Ltd., average particle diameter 1 μm), TaC powder (average particle diameter 1 μm), TiO₂ powder (“TTO-V-3” manufactured by ISHIHARA SANGYO KAISHA, LTD.), Nb(OH)₅ powder (“niobium hydroxide” manufactured by MITSUI MINING & SMELTING CO., LTD.), Ni powder, VC powder, and Cr₃C₂ powder were prepared. Average particle diameters of the Ni powder, the VC powder, and the Cr₃C₂ powder were each 1 μm.

When both of the TiO₂ powder and the Nb(OH)₅ powder were used, these were introduced into water and strongly stirred with an attritor to prepare a TiO₂—Nb₂O₅ precursor solution.

### <Mixing Step>

The raw materials were mixed at ratios described in Table 1. The ratio (mass %) of each raw material described in Table 1 is a ratio when the total of the raw materials is 100 mass %. “Balance” in Table 1 shows that the ratio of WC powder is a value obtained by subtracting the ratio of the total of other raw materials from 100 mass % of the total of the raw materials. “-” in Table 1 indicates that the applicable raw material is not used. In a sample using both of TiO₂ and Nb₂O₅, the TiO₂—Nb₂O₅ precursor solution was mixed with other raw materials so as to satisfy the ratios of “TiO₂” and “Nb₂O₅” in Table 1. The mixing conditions are as A or B below. The conditions B are conventional common mixing conditions. The mixing conditions used for each sample are shown in Table 2.
A: A ball mill is used. The mixing conditions are the number of revolutions of 66 rpm, a ball diameter φ of 6 mm, and a mixing time of 24 hours.
B: An attritor is used. The mixing conditions are the number of revolutions of 100 rpm, a ball diameter φ of 6 mm, and a mixing time of 6 hours.

TABLE 1

| | Raw material | | | | | | | |
|---|---|---|---|---|---|---|---|---|
| Sample | WC | Co | Ni | TaC | Cr₃C₂ | VC | TiO₂ | Nb₂O₅ |
| No. | mass % | mass % | mass % | mass % | mass % | mass % | mass % | mass % |
| 1 | balance | 12.00 | — | — | 0.50 | — | 0.30 | 0.03 |
| 2 | balance | 12.00 | — | — | 0.50 | — | 0.30 | 0.03 |
| 3 | balance | 12.00 | — | — | 0.50 | — | 0.30 | 0.03 |
| 4 | balance | 12.00 | — | 2.00 | 0.40 | 0.10 | 0.30 | — |
| 5 | balance | 12.00 | — | 2.00 | 0.40 | 0.10 | 0.30 | — |
| 6 | balance | 12.00 | — | 2.00 | 0.40 | 0.10 | 0.30 | — |
| 7 | balance | 9.00 | 7.00 | 5.00 | 0.50 | 0.20 | 0.30 | 0.03 |
| 8 | balance | 9.00 | 7.00 | 5.00 | 0.50 | 0.20 | 0.30 | 0.03 |
| 9 | balance | 9.00 | 7.00 | 5.00 | 0.50 | 0.20 | 0.30 | 0.03 |
| 10 | balance | 2.80 | — | — | 0.10 | — | 0.10 | 0.01 |
| 1-1 | balance | 12.00 | — | — | 0.50 | — | 0.30 | 0.03 |
| 1-2 | balance | 12.00 | — | — | 0.50 | — | 0.30 | 0.03 |
| 1-3 | balance | 7.00 | 8.00 | 5.00 | 0.50 | 0.20 | 0.30 | 0.03 |
| 1-4 | balance | 2.50 | — | — | 0.10 | — | 0.10 | — |
| 1-5 | balance | 12.00 | — | 5.00 | 0.50 | — | 0.10 | 0.01 |
| 1-6 | balance | 12.00 | — | — | 0.50 | — | — | — |
| 1-7 | balance | 7.00 | 8.00 | 4.00 | 0.50 | 0.20 | 0.50 | 0.05 |

### <Shaping Step>

The mixed powder was pressed to obtain a round-bar shaped green body and an indexable cutting insert (model number: CNMG120408N-GU)-shaped green body.

### <Sintering Step>

The green body was placed in a furnace, heated up to a temperature described in the column “First stage temperature/Time” in Table 2 under the conditions described in the column “Atmosphere/Pressure” of “Sintering” in Table 2 (“Ar-6.7 kPa” means an argon atmosphere and a pressure of 6.7 kPa. “N₂—30 kPa” means an N₂ atmosphere and a pressure of 30 kPa. “N₂—30 kPa” means an N₂ atmosphere and a pressure of 30 kPa. “N₂—6.7 kPa” means an N₂ atmosphere and a pressure of 6.7 kPa.) at a heating rate of 20° C./min up to a temperature described in the column “Temperature/Time” in Table 2, and held at the temperature for a time described in the column “Temperature/Time”. Subsequently, the green body was cooled down to 25° C. at a cooling rate described in the column “Cooling rate” in Table 2 to obtain a cemented carbide intermediate body.

TABLE 2

| | | Sintering | | | |
|---|---|---|---|---|---|
| | | Heating | | | Cooling |
| | | rate | | | rate |
| Sample | Mixing | ° C./ | Temperature/ | Atmosphere/ | ° C./ |
| No. | conditions | min | Time | Pressure | min |
| 1 | A | 20 | 1350° C.-2 h | Ar-6.7 kPa | −50 |
| 2 | A | 20 | 1350° C.-2 h | N₂-30 kPa | −50 |
| 3 | A | 20 | 1350° C.-2 h | N₂-6.7 kPa | −50 |
| 4 | A | 20 | 1350° C.-2 h | Ar-6.7 kPa | −50 |
| 5 | A | 20 | 1350° C.-2 h | N₂-30 kPa | −50 |
| 6 | A | 20 | 1350° C.-2 h | N₂-6.7 kPa | −50 |
| 7 | A | 20 | 1350° C.-2 h | Ar-6.7 kPa | −50 |
| 8 | A | 20 | 1350° C.-2 h | N₂-30 kPa | −50 |
| 9 | A | 20 | 1350° C.-2 h | N₂-6.7 kPa | −50 |
| 10 | A | 20 | 1350° C.-2 h | N₂-6.7 kPa | −50 |
| 1-1 | B | 20 | 1400° C.-1 h | Ar-6.7 kPa | −20 |
| 1-2 | B | 20 | 1400° C.-1 h | N₂-30 kPa | −20 |
| 1-3 | A | 20 | 1350° C.-2 h | N₂-30 kPa | −50 |
| 1-4 | A | 20 | 1350° C.-2 h | N₂-6.7 kPa | −50 |
| 1-5 | A | 20 | 1350° C.-2 h | Ar-6.7 kPa | −50 |
| 1-6 | A | 20 | 1350° C.-2 h | N₂-30 kPa | −50 |
| 1-7 | A | 20 | 1350° C.-2 h | N₂-30 kPa | −50 |

### <HIP Step>

The cemented carbide intermediate body was subjected to HIIP under the conditions described in the column “HIP” in Table 3. Thereafter, it was cooled to obtain a cemented carbide.

TABLE 3

| | HIP |
|---|---|
| Sample | Conditions |
| No. | Temperature/Atmosphere/Pressure/Time |
| 1 | 1100° C.-Ar200 MPa-2 h |
| 2 | 1100° C.-Ar200 MPa-2 h |
| 3 | 1100° C.-Ar200 MPa-2 h |
| 4 | 1100° C.-Ar200 MPa-2 h |
| 5 | 1100° C.-Ar200 MPa-2 h |
| 6 | 1100° C.-Ar200 MPa-2 h |
| 7 | 1100° C.-Ar200 MPa-2 h |
| 8 | 1100° C.-Ar200 MPa-2 h |
| 9 | 1100° C.-Ar200 MPa-2 h |
| 10 | 1100° C.-Ar200 MPa-2 h |
| 1-1 | 1300° C.-Ar10 MPa-1 h |
| 1-2 | 1300° C.-Ar10 MPa-1 h |
| 1-3 | 1100° C.-Ar200 MPa-2 h |
| 1-4 | 1100° C.-Ar200 MPa-2 h |
| 1-5 | 1100° C.-Ar200 MPa-2 h |
| 1-6 | 1100° C.-Ar200 MPa-2 h |
| 1-7 | 1100° C.-Ar200 MPa-2 h |

### [Evaluation of Cemented Carbide]

### <Content of First Hard Phase, Content of Binder Phase, Content of Second Hard Phase, and Content of Third Hard Phase in Cemented Carbide>

A content (vol %) of the first hard phase, a content (vol %) of the binder phase, a content (vol %) of the second hard phase, and a content (vol %) of the third hard phase in the cemented carbide of each sample were measured by the method described in Embodiment 1. The results are shown in Table 4.

TABLE 4

Cemented carbide

| | | | | First | |
|---|---|---|---|---|---|
| | | | | hard phase + | |
| | First | Second | | Second | Third |
| | hard | hard | Binder | hard phase + | hard |
| Sample | phase | phase | phase | Binder phase | phase |
| No. | vol % | vol % | vol % | vol % | vol % |
| 1 | 79.2 | 0.7 | 19.1 | 99.0 | 0.5 |
| 2 | 79.1 | 0.7 | 18.9 | 98.7 | 0.2 |
| 3 | 79.2 | 0.7 | 19.0 | 98.9 | 0.3 |
| 4 | 78.5 | 2.5 | 18.3 | 99.3 | 0.5 |
| 5 | 78.4 | 2.5 | 18.3 | 99.2 | 0.5 |
| 6 | 78.7 | 2.5 | 18.0 | 99.2 | 0.5 |
| 7 | 69.3 | 0.2 | 24.6 | 94.1 | 4.7 |
| 8 | 65.4 | 4.9 | 24.7 | 95.0 | 0.2 |
| 9 | 68.8 | 2.6 | 24.6 | 96.0 | 0.7 |
| 10 | 94.3 | 0.18 | 4.8 | 99.3 | 0.1 |
| 1-1 | 79.1 | 0.7 | 18.9 | 98.7 | 0.2 |
| 1-2 | 79.4 | 0.7 | 19.1 | 99.2 | 0.3 |
| 1-3 | 64.9 | 4.0 | 23.8 | 92.7 | 0.2 |
| 1-4 | 95.5 | 0.1 | 3.9 | 99.5 | 0.1 |
| 1-5 | 73.5 | 5.1 | 18.8 | 97.4 | 0.5 |
| 1-6 | 80.1 | 0.0 | 19.1 | 99.2 | — |
| 1-7 | 64.0 | 5.5 | 23.0 | 92.5 | 0.2 |

<Standard Deviation sd of Heywood Diameters of Tungsten Carbide Particles in Particle Size Distribution on a Volume Basis, Volume Mean Diameter mv of Tungsten Carbide Particles, Composition of Second Hard Phase, and Particle Size Distribution of Second Hard Phase>

Regarding the cemented carbide of each sample, a standard deviation sd of Heywood diameters of the tungsten carbide particles in the particle size distribution on a volume basis, a volume mean diameter mv of the tungsten carbide particles, composition of the second hard phase, and a particle size distribution of the second hard phase were measured by the methods described in Embodiment 1. The results are shown in Table 5. In Table 5, a percentage of the number of the second hard phases having a diameter of 0.2 μm or less relative to the number of all of the second hard phases is shown in the column “Diameter 0.2 μm or less”. In Table 5, a percentage of the number of the second hard phases having a diameter of 0.6 μm or more relative to the number of all of the second hard phases is shown in the column “Diameter 0.6 μm or more”

TABLE 5

| | WC particles | | | | |
|---|---|---|---|---|---|
| | Standard | | Second hard phase | | |
| | deviation | Volume | | Diameter | Diameter |
| | sd of | mean | | 0.2 | 0.6 |
| | Heywood | diameter | | μm or | μm or |
| Sample | diameters | mv | | less | more |
| No. | μm | μm | Composition | % | % |
| 1 | 0.20 | 0.64 | TiNbC | 12 | 19 |
| 2 | 0.13 | 0.30 | TiNbN | 18 | 14 |
| 3 | 0.10 | 0.18 | TiNbCN | 10 | 10 |
| 4 | 0.25 | 0.67 | TiTaC | 30 | 30 |
| 5 | 0.18 | 0.40 | TiTaN | 22 | 12 |
| 6 | 0.19 | 0.30 | TiTaCN | 24 | 22 |
| 7 | 0.17 | 0.30 | TiTaNbC | 25 | 27 |
| 8 | 0.23 | 0.40 | TiTaNbN | 19 | 26 |
| 9 | 0.16 | 0.40 | TiTaNbCN | 17 | 20 |
| 10 | 0.23 | 0.20 | TiNbCN | 28 | 27 |
| 1-1 | 0.27 | 0.30 | TiNbC | 28 | 27 |
| 1-2 | 0.08 | 0.20 | TiNbCN | 10 | 10 |
| 1-3 | 0.23 | 0.40 | TiTaNbN | 32 | 31 |
| 1-4 | 0.23 | 0.20 | TiCN | 28 | 26 |
| 1-5 | 0.20 | 0.40 | TiNbC | 12 | 19 |
| 1-6 | 0.13 | 0.30 | — | 0 | 0 |
| 1-7 | 0.20 | 0.30 | TiTaNbN | 25 | 22 |

### <Cobalt Content in Binder Phase, Composition of Third Hard Phase, and Cumulative 50% Particle Diameter D50 of Third Hard Phase on Area Basis>

Regarding the cemented carbide of each sample, a cobalt content in the binder phase, composition of the third hard phase, and a cumulative 50% particle diameter D50 of the third hard phase on an area basis were measured by the methods described in Embodiment 1. The results are shown in Table 6.

TABLE 6

| | |
|---|---|
| Binder phase | Third hard phase |

| Sample | Co content | | D50 |
|---|---|---|---|
| No. | mass % | Composition | μm |
| 1 | 100 | TiWNbC | 0.5 |
| 2 | 100 | TiWNbN | 0.4 |
| 3 | 100 | TiWNbCN | 0.1 |
| 4 | 100 | TiWTaC | 0.2 |
| 5 | 100 | TiWTaN | 0.1 |
| 6 | 100 | TiWTaCN | 0.1 |
| 7 | 54 | TiTaWNbC | 2.2 |
| 8 | 54 | TiTaWNbN | 2.9 |
| 9 | 54 | TiTaWNbCN | 1.7 |
| 10 | 100 | TiWNbCN | 1.2 |
| 1-1 | 100 | TiWNbC | 0.5 |
| 1-2 | 100 | TiWNbCN | 0.1 |
| 1-3 | 47 | TiTaWNbN | 2.8 |
| 1-4 | 100 | TiWCN | 1.1 |
| 1-5 | 100 | TiWNbC | 0.5 |
| 1-6 | 100 | — | — |
| 1-7 | 47 | TiTaWNbN | 2.8 |

### [Cutting Test 1]

A round bar composed of the cemented carbide of each sample was processed to produce a radius endmill having a cutting diameter φ of 6 mm. Using the radius endmill, side processing of Ti-64 alloy was performed. The processing conditions were a cutting speed Vc of 200 m/min, a feed per tooth fz of 0.1 mm/t, a cutting depth (axial direction) ap of 2.0 mm, a cutting depth (radial direction) ae of 2.0 mm, and a wet system. A cutting length before cutting edge chipping occurred was measured. The results are shown in the column “Cutting length” of “Cutting Test 1” in Table 7. When the cutting length is 200 m or more, the tool lifetime is judged to be long. The above processing conditions correspond to the high-speed processing of titanium alloy.

### [Cutting Test 2]

Using an indexable cutting insert (model number: CNMG120408N-GU) composed of the cemented carbide of each sample, continuous turning of SUS316 was performed. The turning conditions were a cutting speed Vc of 300 m/min, a feed f of 0.2 mm/t, a cutting depth ap of 2.0 mm, and a wet system. A cutting time before flank face wear became 0.2 mm was measured. The results are shown in the column “Cutting time” of “Cutting Test 2” in Table 7. When the cutting time is 10 minutes or more, the tool lifetime is judged to be long. The above processing conditions correspond to the high-speed processing of stainless steel.

TABLE 7

| | Cutting Test 1 | Cutting Test 2 |
|---|---|---|
| Sample | Cutting length | Cutting time |
| No. | m | min |
| 1 | 226 | 15 |
| 2 | 222 | 14 |
| 3 | 211 | 12 |
| 4 | 264 | 23 |
| 5 | 228 | 15 |
| 6 | 241 | 18 |
| 7 | 243 | 19 |
| 8 | 243 | 19 |
| 9 | 229 | 16 |
| 10 | 256 | 21 |
| 1-1 | 164 | 8 |
| 1-2 | 175 | 2 |
| 1-3 | 164 | 8 |
| 1-4 | 165 | 7 |
| 1-5 | 171 | 4 |
| 1-6 | 160 | 3 |
| 1-7 | 164 | 8 |

The cemented carbides and the cutting tools of Sample 1 to Sample 10 correspond to Examples. It has been confirmed in Cutting Tests 1 and 2 that these cutting tools have long tool lifetimes.

The cemented carbides and the cutting tools of Sample 1-1 to Sample 1-7 correspond to Comparative Examples. These cutting tools had insufficient tool lifetimes in Cutting Tests 1 and 2.

The embodiments and Examples of the present disclosure have been described as above, but it is anticipated in advance that the aforementioned embodiments and constitution of Examples are appropriately combined or variously modified. It should be considered that the embodiments and Examples disclosed herein are examples in all points, and should not be limitative. The scope of the present invention is determined by not the above embodiments nor Examples but the claims, and intended to include meaning equivalent to the claims and all modification within the scope.

### REFERENCE SIGNS LIST

10 Cutting tool; 11 Cutting edge.

1. A cemented carbide comprising a first hard phase, a second hard phase, and a binder phase, wherein
the first hard phase is composed of a plurality of tungsten carbide particles,
the second hard phase is composed of at least one first compound selected from the group consisting of TiNbC, TiNbN, TiNbCN, TiTaC, TiTaN, TiTaCN, TiTaNbC, TiTaNbN, and TiTaNbCN,
the binder phase contains cobalt at 50 mass % or more,
a total content of the first hard phase, the second hard phase, and the binder phase in the cemented carbide is 94 vol % or more,
a content of the first hard phase in the cemented carbide is 65.0 vol % or more and 95.0 vol % or less,
a content of the second hard phase in the cemented carbide is 0.1 vol % or more and 5.0 vol % or less,
a content of the binder phase in the cemented carbide is 4.0 vol % or more and 25.0 vol % or less,
a standard deviation sd of Heywood diameters of the tungsten carbide particles in the particle size distribution on a volume basis is 0.10 μm or more and 0.25 μm or less,
a percentage of the number of the second hard phases having a diameter of 0.2 μm or less relative to the number of all of the second hard phases is 10% or more and 30% or less, and
a percentage of the number of the second hard phases having a diameter of 0.6 μm or more relative to the number of all of the second hard phases is 10% or more and 30% or less.

2. The cemented carbide according to claim 1, wherein a volume mean diameter mv of the tungsten carbide particles is 0.2 μm or more and 0.65 μm or less.

3. The cemented carbide according to claim 1, further comprising a third hard phase, wherein
the third hard phase is composed of at least one second compound selected from the group consisting of TiWNbC, TiWNbN, TiWNbCN, TiWTaC, TiWTaN, TiWTaCN, TiTaWNbC, TiTaWNbN, and TiTaWNbCN, and
a content of the third hard phase in the cemented carbide is 0.1 vol % or more and 5 vol % or less.

4. The cemented carbide according to claim 3, wherein a cumulative 50% particle diameter D50 of the third hard phase on an area basis is 0.1 μm or more and 3.0 μm or less.

5. A cutting tool comprising a cutting edge composed of the cemented carbide according to claim 1.
